(19) United States
(12) Patent Application Publication
(10) Pub. No.: US 2003/0027052 A1
(43) Pub. Date: Feb. 6, 2003

(54) Cationic conductive material

(76) Inventors: Yuhong Huang, West Hills, CA (US); Qiang Wei, West Hills, CA (US); Haixing Zheng, Oak Park, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/917,503

(22) Filed: Jul. 27, 2001

(51) Int. Cl. H01M 10/36

(52) U.S. Cl. 429/304; 429/322; 252/62.2

(57) ABSTRACT

An electrolyte comprising a cationic species disposed in a polyoxometalate network. A composition comprising cationic species and polyoxometalate anionic species, wherein the polyoxometalate anionic species are coupled through a network of bridge ligands. An apparatus comprising a first electrode and a second electrode; a current collector coupled to one of the first and the second electrode; and an electrolyte disposed between the first electrode and the second electrode, the electrolyte comprising a cationic species disposed in a polyoxometalate network.

This invention was made with Government support under contract DASG60-00-M-0148 awarded by BMDO. The Government has certain rights in this invention.

### BACKGROUND

1. Field

The field generally relates to cationic conductive material, including the field of methods for and products of manufacturing component parts in energy storage devices.

2. Background

Solid electrolytes conceptually consist of solid atomic structures, which selectively conduct a specific ion through a network of sites in a two or three dimensional matrix. If the activation energy for mobility is sufficiently low, a solid electrolyte can serve as both the separator and electrolyte in a battery. This theoretically allows the fabrication of an all solid state cell.

A solid electrolyte device has several advantages over those based on liquid electrolytes. These advantages include: (1) the capability of pressure-packaging or hard encapsulation to yield extremely rugged assemblies; (2) the extension of the operating temperature range since the freezing and/or boiling-off of the liquid phase, which can drastically affect the device performance when employing liquid electrolytes, are not a consideration; (3) a truly leak-proof device; (4) a longer shelf life than liquid electrolyte devices, principally due to the inhibition of the corrosion of electrodes and solvent drying out which can occur with liquid electrolytes; (5) micro-miniaturization; and (6) elimination of heavy, rigid battery cases which are essentially “dead weight” because they provide no additional capacity to the battery but must be included in the total weight thereof.

Of the conceptual thin-film, solid state battery systems lithium-polymer batteries have received the most widespread interest. However, in general, all polymer electrolytes reported in these systems to date are not true solid electrolytes.

Several lithium salts have been disclosed as solid lithium ion conductive electrolytes, including lithiated silicon nitride (Li₈SiN₄), lithium phosphate (LiPO₄), lithium titanium phosphate (LiTiPO₄) and lithium phosphonitride or LIPON (LiPO₄₋₈Nₓ, where 0<x<4). Among these lithium salts, only lithium phosphonitride (LIPON) with a composition of Li_{2.9}PO_{3.3}N_{0.36} possesses generally high ion conductivity, e.g., on the order of 2×10⁻⁶ S/cm. One concern over LIPON, however, is that it can react with water and release toxic phosphor gas. Further, extremely slow rates of deposition of electrolyte films of LIPON prevent the thin film battery technology from being used in commercial applications.

What is needed is an improved cationic conductive material that can be used in energy storage devices and systems.

### BRIEF DESCRIPTION OF THE DRAWINGS

Referring particularly to the drawings for the purpose of illustration only and not limitation, there is illustrated:

FIG. 1 is scheme of the structure of functionalized polymer contain polyoxomolybdate units and lithium ions as the spectator cations.

FIG. 2 is a schematic, cross-sectional side view of an embodiment of a thin film battery.

FIG. 3 is a graphical representation of the thermal reaction behavior of polyoxomolybdate polymer electrolyte.

### DETAILED DESCRIPTION

An electrolyte comprising a cationic species disposed in a polyoxometalate (POM) network is described. In one embodiment, the anionic polyoxometalates are functionalized into a network with a variety of bridge ligands. Suitable bridge ligands are selected from organic, inorganic or hybrid ligands. In another embodiment, the network comprises one or more ligands bound to lacunary polyoxometalates. The functionalization improves the film formability of the composition for use as a component in an electrochemical device, including a solid electrolyte, for electrochemical devices such as batteries (e.g., lithium batteries), electrochromic devices, and capacitors.

A composition comprising cationic species and polyoxometalate anionic species is also described. In one embodiment, the polyoxometalate anionic species are coupled through a network of bridge ligands to form a functionalized composition useful in one aspect as an electrolyte for an electrochemical device. In another embodiment, the polyoxometalate anionic species are lacunary species to which one or more ligands are bound to form a network. For example, a composition including a cationic species of lithium may be used as an electrolyte in a solid state, lithium battery.

An apparatus, such as a battery, comprising a first electrode, a second electrode and a current collector coupled to one of the first and second electrode is further described. The apparatus also includes an electrolyte disposed between the first electrode and the second electrode. The electrolyte comprises a cationic species, such as lithium, disposed in a polyoxometalate network.

A method is still further described. In one embodiment, the method includes forming a solution of a composition comprising cationic species and polyoxometalate anionics and introducing the solution as a film onto a surface of a substrate. In one aspect, the method may be practiced in forming an electrolyte as part of an electrochemical cell. Representative introduction techniques include spray coating, spinning, and dip coating. Where the solution further comprises a solvent, the solvent may be driven off to form a solid electrolyte.

In various embodiments described herein, polyoxometalates (POM) are utilized. Polyometalates are a class of metal oxide anions with characteristic structures based on highly symmetrical core assemblies. The number and variety of inorganic compounds are large. The size of polyoxometalates vary from generally smaller anions like [Mo₂O₇]^{2—} to generally larger ones like [P₈W₄₈O₁₈₄]^{40—}. The composition of these anions vary from isopolyoxometalates which have only one kind of metal center, to heteropoly-oxometalates with a representative formula of [XₙMₓO_{y}]^{q—} in which the hetero-atom X has been found from more than 65 elements of all groups in the Periodic Table of the Elements except for noble gas elements. Due to its core assembly nanostructure, immobile large anion, and very weak interaction with cations, polyoxometalates have unique high ion conductivity and high thermal stability. Thus, polyoxometalates have been exploited for their solid-state proton conductivity in applications such as electrochromic devices, supercapacitors, fuel cells, sensors, and electrochemical cells.

Among the various polyoxometalates, phosphotungstic acid (PWA) and phosphomolybdic acid (PMA) in their 30-water molecule hydrate forms (H₃PW₁₂O₄₀.30H₂O and H₃PMo₁₂O₄₀.30H₂O, respectively) are characterized by considerable protonic conductivity, due, it is believed, to the proton “hopping” in the hydrogen bonded networks facilitated by hydrate molecules. More specifically, solid state, room temperature PWA has a protonic conductivity of about 0.17 S/cm, and PMA, also at room temperature, has a protonic conductivity of about 0.18 S/cm.

Polyoxometalates have been formed as salt clusters (e.g., lithium salts). Heretofore, such clusters are not suitable for use in film applications such as thin film applications because the salts tend to cluster without organization making deposition on a substrate problematic.

In one embodiment, polyoxometalates (e.g., polyoxometalate anions) are functionalized through bridge ligands to improve the film formability and membrane formability of the resulting composition. Suitable polyoxometalates anions include generally small anions like [Mo₂O₇]^{2—} to generally large anions like [P₈W₄₈O₁₈₄]⁻⁴⁰, isopolyoxometalates, as well as heteropolyoxometalates. Suitable bridge ligands to functionalize the polyoxometalate anions include organic, inorganic, or hybrid ligands, including but not limited to diimidos, functional silanes, metal alkoxides, and organic polymers such as polyurethanes and polystyrenes.

In terms of polyoxometalate salts, suitable cations that can be combined with functionalized polyoxometalate anions will depend in part on the application to which the salt is employed. Suitable salts for electrochemical applications where high ion conductivity is generally desired include, but are not limited to, protons (H⁺), lithium (Li⁺), ammonium (NH₄⁺), and ammonium derivatives (e.g., tetrabutylammonium).

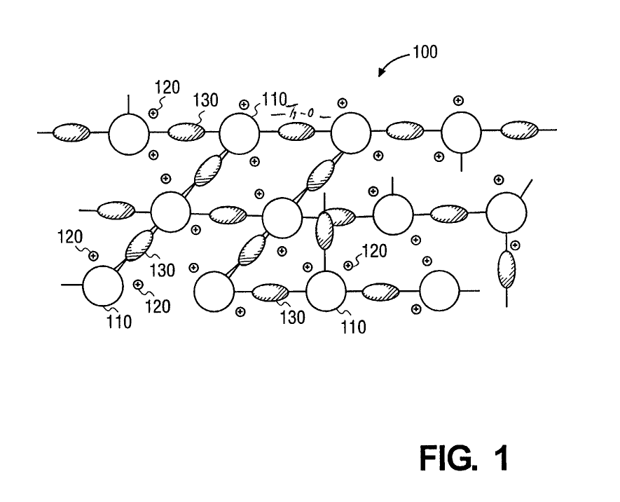

FIG. 1 schematically illustrates a network of polyoxometalate salts functionalized through bridge ligands. Network 100 is representatively described as a polymer including polyoxometalate anions 110 coupled to one another through bridge ligands 130 (e.g., covalently bonded bridge ligands). Cations 120 are associated with polyoxometalate anions throughout the network.

Forming a network (e.g., polymer network) of polyoxometalate salts allows the network composition to be introduced on a substrate by way of a solution process. In the formation of a thin film electrochemical cell, for example, the polyoxometalate salts can be introduced by a solution process such as spray-coating, spin-coating, and dip-coating, with any solvent subsequently driven off to form a solid network. Combining the functionalized polyoxometalate salts with solvents that can be driven off at relatively low temperatures (e.g., on the order of 150° C.), further the compatibility of thin film electrochemical cells with temperature sensitive substrates and/or integrated circuit chips.

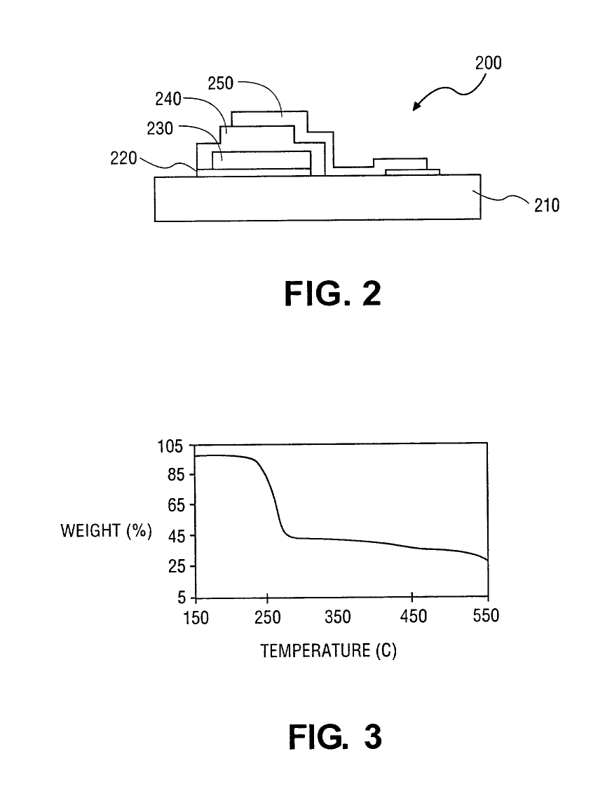

FIG. 2 schematically illustrates a cross-sectional side view of a substrate having an electrochemical cell such as a thin film battery formed thereon. In this example, structure 200 includes substrate 210 of a generally insulating material such as a ceramic material or glass (e.g., silicon on glass). Alternatively, substrate 210 is a semiconductor (e.g., silicon) material optionally having an insulating material such as an oxide (e.g., silicon dioxide) formed on a surface (surface 205).

Formed on (overlying) surface 205 of a portion of substrate 210 is a thin film battery. The thin film battery includes current collector 220 formed on substrate surface 205. Current collector 220 is a conductive material of, for example, Platinum/Cobalt (Pt/Co) or molybdenum (Mo). Current collector 220 is formed by deposition techniques, such as radio-frequency (RF) sputtering.

Referring to FIG. 2, formed on current collector 220 is cathode 230. Cathode 230 is, for example, a transition metal oxide such as LiCoO₂ introduced by sputtering. Other methods for introducing Cathode 230 includes, but are not limited to, spinning-on, spraying, and printing.

Formed on cathode 230 of the thin film battery illustrated in FIG. 2 is electrolyte 240. In this embodiment, electrolyte 240 is a functionalized polyoxometalate salt (e.g., functionalized through coupling polyoxometalate anions in a network through bridge ligands). Electrolyte 240 is introduced on to surface 205 of substrate 210 through a solution process such as spray-coating, spin-coating, or dip-coating. In one embodiment, prior to introduction (deposition), electrolyte 240 is combined with a solvent that is driven off, optionally with the addition of heat, following the introduction of the solution. A thin film having a representative thickness of 10 to 30 microns is suitable.

Formed on electrolyte 240 of the thin film battery illustrated in FIG. 2 is anode 250. Anode 250 is a conductive material such as lithium metal. One way to introduce lithium metal is through an evaporation process.

One way to form a polyoxometalate network such as illustrated in FIG. 1 and the film illustrated as an electrolyte in FIG. 2 is by reacting a salt with a diisocyanate to form an organo diimido bridge polymer network. Example 1 describes the preparation of a polymer network where the polyoxometalate anion is [Mo₆O₁₉]^{2—} and the cation is lithium (or a mixture of lithium and tetrabutylammonium).

### EXAMPLE 1

### Preparation of Functionalized Polyoxomolybdatepolymer Coating

[Mo₆O₁₉]^{2—} monomer, bearing with tetrabutylammonium, is synthesized by reacting tetrabutylammonium bromide to sodium molybdate dihydrate in dimethylformamide at low pH (e.g., pH of 2 or lower). The following reactions take place to form [Bu₄N]₂[Mo₆O₁₉] monomer:

Na₂MoO₄2H₂O+(CH₃CO)₂O+H⁺→H₂Mo₆O₁₉

H₂Mo₆O₁₉+2(C₄H₉)₄NBr→Mo₆O₁₉(NC₁₆H₃₆)₂+2HBr

Reaction of [Bu₄N]₂[Mo₆O₁₉] with diisocyanate in dry pyridine occurs with evolution of CO₂ and formation of the corresponding organodiimido bridged polymer:

[Mo₆O₁₉]^{2—}+[1,3—OCNC₆H₄NCO]→[—Mo₆O₁₈(NC₆H₄N)—]ₙ

Lithium ion (Li⁺) exchange of tetrabutylammonium polyoxomolybdate can be carried out in two ways: One way is to use an ion exchange resin column. To load Li⁺ on the resin, DOWEX® cation exchanger 50 WX8-200 beads were mixed with 1 molar lithium hydroxide (LiOH) to form a slurry. The beads are then washed extensively with distilled water to remove any traces of unreacted LiOH. The beads are then dried to remove residual water. The ion exchange reaction is performed by adding polyoxomolybdate polymer solution (in pyridine) slowly to the column.

A second way to exchange lithium ion for tetrabutylammonium ion is to do the exchange after the introduction of the polymer as a film on a substrate (such as after the deposition of the thin film electrolyte in FIG. 2) by soaking the tetrabutylammonium polyoxomolybdate film in 120 g/L butanol solution at room temperature for 2 hours. The tetrabutylammonium cation can be partially replaced.

The thermal stability of the polyoxometabolate polymer described in Example 1 is shown in FIG. 3. The thermal decomposition temperature of this polymer is about 230° C.

Example 2 describes a second technique to functionalize polyoxometalates making them suitable for use in, among other applications, film applications. In this example, functionalization is accomplished by creating a network of ligands (one or more) bound to lacunary polyoxometalates. Suitable ligands include, but are not limited to, silicon dioxide (SiO₂), silanes, siloxane, metal oxides (e.g., titanium oxide), metal alkoxides (e.g., RTiCl₃, Ti(BuO)₄, Si(EtO)₄), and cyan moieties.

### EXAMPLE 2

### Functionalization of Keggin-type of Polyoxometalate

Functionalization of Keggin-type of polyoxometalate (e.g., a polyoxometalate having a heteroatom) can be realized by creating as unsaturated or lacunary anion first at a pH value on the order of 5 to 8. For example:

[SiW₁₂O₄₀]^{4—}+(5−x)OH⁻<—>[HₓSiW₁₁O₃₉]^{(7-x)-}+[HWO₄]⁻+(2−x)H₂O

[SiW₁₁O₃₉]^{7—} anion can readily react with, for example, silane in aqueous solution with pH value range of 5 to 7. The silanes are covalently bonded to the surface of the SiW₁₁O₃₉^{8—} anion via Si—O—W bonds between the silicon atoms of the silanes and the oxygens that define the “hole” of the deficient anion.

As an example, the coating solution is prepared by dissolving H₄SiW₁₂O₄₀ in water under stirring, followed by adding LiOH in the solution a little by little with heat to assist dissolving of the LiOH. A pH value is adjusted from 2 to 6. Tetraethoxylsilane and HCl are added into the solution. The mole ratio of H₄POM:LiOH:TEOS:HCl=1:5:3:4, where “POM” is the polyoxometalate. The solution is concentrated by evaporation of water. Isopropanol is then added to a suitable viscosity and solution ready for film deposition with a mole concentration of polyoxometalate of 0.15 mol/L.

In one embodiment, a thin film can deposit via spin-on process. The solution is applied to metallized substrate and covered the whole surface of the substrate, followed by spinning with a spin speed of 85 to 1000 revolutions per minute (RPM) for 20 seconds. The coating is then dried at 150° for half hour.

Still another technique for functionalizing polyoxometalate (POM) salts for use in film applications is dissolving salt clusters in a suitable solvent, solution processing to form a desired film, and driving off the solvent. Example 3 illustrates this technique.

### EXAMPLE 3

### Dissolution and Solution Processing of Lithium Polyoxometalate Salts Li₃ (PW₁₂O₄₀)

Lithium polyoxometalate salt clusters are dissolved into solvent under the magnetic stirring and filtered before use. An example of suitable solvents used included water, ethanol (EtOH) and isopropanol (IPA), separately or a mixture of two or more. The concentration used in this example ranged from concentrated, 60 weight percent, to diluted, one weight percent. The mixed solvent showed better film formability. Less water is generally preferred, because: (1) Alcohol is easier to evaporate than water; and (2) the cluster is less dissolved in alcohol. One example of the final solution is four weight percent of lithium polyoxometalate salts with Water:EtOH:IPA=1:4:4.

Gas flow was controlled to be small enough that the gas does not blow or dissolve the solution coating and big enough to stabilize it. The amount of the solution coating on a substrate was controlled by the distance of substrate to spray gun. When spraying the solution on a heated substrate (e.g., a substrate heated to drive off the solvent), Large amount of solution on substrate tend to decease the surface temperature which favors the solvent staying in solution instead of evaporating. In experiments, the distance of spray gun to substrate was three inches.

The temperature of the substrate was adjusted in the range of room temperature of 250° C. 180° C. to 200° C. are suitable to build up thick coating. Up to 30 microns (μm) thick film has been deposited via spray coating.

### EXAMPLE 4

### Room Temperature Ion Conductivity From Pellet Samples

Pellet samples of Keggin-type lithium hetero-polyoxometalate or polyoxometalate salt clusters were prepared by pressing dried powder at pressure of 1000 kg/cm². The electrochemical characterization of the samples was performed using a Frequency Response Analyzer (FRA) in conjunction with a potentiostat. For the pellet samples, test cells were fabricated consisting of the sample clamped between molybdenum (Mo) and lithium (Li) foil. The ion conductivity of various salt clusters is shown in Table 1.

TABLE 1
Ion Conductivity from Pellets samples

| | Room temperature ion conductivity |
|---|---|
| POM | (S/cm) |
| Li₃PW₁₂O₄₀ | 7.9 × 10⁻⁹ |
| Li₄SiW₁₂O₄₀ | 3.5 × 10⁻⁸ |
| α-Li₅AIW₁₂O₄₀ | 3.2 × 10⁻⁷ |
| Li₇PW₁₁O₃₉ | 2 × 10⁻⁸ |
| Li₆P₂W₁₈O₆₂ | 2.8 × 10⁻⁸ |
| Li₅SiV^{v}W₁₁O₄₀ | 5 × 10⁻⁷ |
| Li₆Al₂W₁₁O₃₉ | 6.6 × 10⁻⁶ |

One advantage of lithium polyoxometalate salts as electrolyte is their weak interaction between lithium cations and big polyoxometalate cage anions, resulting in high ion conductivity. Among the (XW₁₂O₄₀) POM clusters in Table 1, where X=Al, Si and P, the interaction of cation and anion follows the order of Al<Si<P. AlW₁₂O₄₀ has the weakest interaction among these three. Lithium cation loading is also a factor that will affect the conductivity.

In the preceding detailed description, functionalized polyoxometalates and a technique for functionalizing polyoxometalates is described with reference to specific embodiments thereof. One suitable use for the functionalized polyoxometalates is as a salt of a cationic conductive material for electrochemical applications such as storage devices or systems. Suitable energy storage device uses include, but are not limited to, consumer electronics (e.g., smart cards) microelectrical mechanical systems or structures (MEMS), sensors, transmitters, computer equipment (e.g., CMOS-SRAM devices, PCMCIA cards) medical devices and communication systems. It will, however, be evident that various modifications and changes may be made to the embodiments described without departing from the broader spirit and scope of the invention as set forth in the claims. The specification and drawings are, accordingly, to be regarded in an illustrative rather than a restrictive sense.

What is claimed is:

1. An electrolyte comprising a cationic species disposed in a polyoxometalate network.

2. The electrolyte of claim 1, wherein the cationic species comprises at least one of lithium, hydrogen, and an ammonium ion.

3. The electrolyte of claim 1, wherein the polyoxometalate network comprises a bridge ligand include diimido moieties.

4. The electrolyte of claim 1, wherein the polyoxometalate network comprises a bridge ligand selected from the group consisting of silane and metal alkoxide moieties.

5. The electrolyte of claim 1, wherein the polyoxometalate network comprises a bridge ligand selected from the group consisting of polyurethane and polystyrene moieties.

6. The electrolyte of claim 1, wherein the polyoxometalate network comprises an anionic species of a Keggin-type polyoxometalate.

7. The electrolyte of claim 1, wherein the polyoxometalate network comprises an anionic species of a polyoxomolybdate.

8. The electrolyte of claim 1, wherein the polyoxometalate network comprises a ligand coupled to a lacunary polyoxometalate.

9. The electrolyte of claim 8, wherein the ligand is selected from the group consisting of silicon dioxide, a silane, a siloxane, a metal oxide, a metal alkoxide, and a cyan moiety.

10. A composition comprising:
cationic species and polyoxometalate anionic species, wherein the polyoxometalate anionic species are coupled through a network.

11. The composition of claim 10, wherein the cationic species comprises at least one of lithium, hydrogen, and an ammonium ion.

12. The composition of claim 10, wherein the polyoxometalate anionic species are coupled through a network of bridge ligands and the bridge ligands comprise diimido moieties.

13. The composition of claim 10, wherein the polyoxometalate anionic species are coupled through a network of bridge ligands and the bridge ligands are selected from the group consisting of silane and metal alkoxide moieties.

14. The composition of claim 10, wherein the polyoxometalate anionic species are coupled through a network of bridge ligands and the bridge ligands are selected from the group consisting of polyurethane and polystyrene moieties.

15. The composition of claim 10, wherein the polyoxometalate anionic species comprise Keggin-type polyoxometalate species.

16. The composition of claim 10, wherein the polyoxometalate anionic species comprise polyoxomolybdate.

17. The composition of claim 1, wherein the network comprises a ligand coupled to a lacunary polyoxometalate.

18. The composition of claim 10, wherein the ligand is selected from the group consisting of silicon dioxide, a silane, a siloxane, a metal oxide, a metal alkoxide, and a cyan moiety.

19. An apparatus comprising:
a first electrode and a second electrode;
a current collector coupled to one of the first and the second electrode; and
an electrolyte disposed between the first electrode and the second electrode, the electrolyte comprising a cationic species disposed in a polyoxometalate network.

20. The apparatus of claim 19, wherein the cationic species comprises at least one of lithium, hydrogen, and an ammoniumion.

21. The apparatus of claim 19, wherein the polyoxometalate network comprises polyoxometalate anionic species coupled through bridge ligands comprising diimido moieties.

22. The apparatus of claim 19, wherein the polyoxometalate network comprises polyoxometalate anionic species coupled through bridge ligands selected from the group consisting of silane and metal alkoxide moieties.

23. The apparatus of claim 19, wherein the polyoxometalate network comprises a bridge ligand selected from the group consisting of polyurethane and polystyrene moieties.

24. The apparatus of claim 19, wherein the polyoxometalate network comprises a ligand coupled to a lacunary polyoxometalate.

25. The apparatus of claim 19, wherein the ligand is selected from the group consisting of silicon dioxide, a silane, a siloxane, a metal oxide, a metal alkoxide, and a cyan moiety.

26. A method comprising:
forming a solution of a composition comprising cationic species and polyoxometalate anionic species, wherein the polyoxometalate anionic species are coupled through a network of bridge ligands; and
introducing the solution as a film onto a surface of a substrate.

27. The method of claim 26, wherein introducing the solution onto a substrate comprises one of spray coating, spinning, and dip coating.

28. The method of claim 26, wherein forming the solution comprises combining the composition with a solvent.

29. The method of claim 28, following introducing the evaporating solution, the method comprising the solvent.
